(19) United States
(12) Patent Application Publication
(10) Pub. No.: US 2013/0125155 A1
(43) Pub. Date: May 16, 2013

(54) DYNAMIC ADAPTATION OF DISPLAYED VIDEO QUALITY BASED ON VIEWERS' CONTEXT

(71) Applicants: Sitaram Bhagavathy, Plainsboro, NJ (US); Cristina Gomila, Princeton, NJ (US)

(72) Inventors: Sitaram Bhagavathy, Plainsboro, NJ (US); Cristina Gomila, Princeton, NJ (US)

(73) Assignee: THOMSON LICENSING, Issy de Moulineaux (FR)

(21) Appl. No.: 13/811,289

(22) PCT Filed: Feb. 16, 2011
(86) PCT No.: PCT/US2011/000283

§ 371 Date: Jan. 21, 2013

Related U.S. Application Data
(60) Provisional application No. 61/367,570, filed on Jul. 26, 2010.

(51) Int. Cl. H04N 21/24

(52) U.S. Cl. CPC H04N 21/24
USPC 725/10

(57) ABSTRACT

A Context-Aware Content-Presentation system includes a viewer context feedback for determining the viewer context relative to a display device. A content receiving device controls at least one parameter of video content streamed to the display device from a streaming server in accordance with the viewer context. In this way, when the viewer context allows for lower quality video content, the content receiving device can signal the streaming server to reduce the quality of the video content, thereby saving bandwidth.

### CROSS-REFERENCE TO RELATED APPLICATIONS

This application claims priority under 35 U.S.C. 119(e) to U.S. Provisional Patent Application Ser. No. 61/367,570, filed Jul. 26, 2010, the teachings of which are incorporated herein.

### TECHNICAL FIELD

This invention to a technique for changing the content displayed to a viewer based on environmental changes and/or and changes in viewer preferences.

### BACKGROUND ART

Proposals exist for Interactive display systems that generally adapt content rendering to viewer context, that is to say, the viewer's relationship to a display device, particularly for video game applications. Currently there exist streaming systems, for example, Netflix and Hulu that vary the video bit rate and resolution based on the available receiver bandwidth. None of these systems appear to utilize any feedback of the viewing conditions or viewer context, let alone target Context-Aware, Content Presentation (CACP) applications that dynamically vary the video quality in accordance with the viewer's context.

### BRIEF SUMMARY OF THE INVENTION

Briefly, in accordance with a preferred embodiment of the present principles, a method for varying video quality in accordance with viewer context commences by establishing the viewer's context relative to a display device. At least one parameter of video information is controlled in accordance with the established viewer context to vary the video quality.

### BRIEF DESCRIPTION OF THE DRAWINGS

FIG. 1 depicts an exemplary context-aware content presentation (CACP) system; and;

FIG. 2 depicts an embodiment of a context-aware content presentation system in accordance with the present principles for varying the quality of the video content in accordance with the viewer's context relative to a display device.

### DETAILED DESCRIPTION

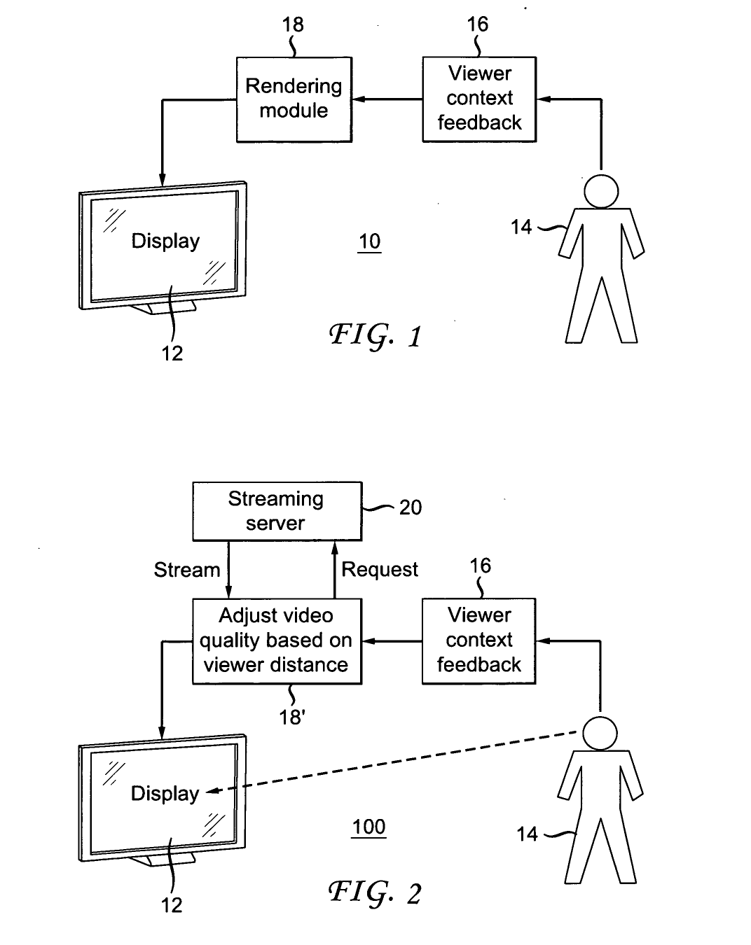

FIG. 1 shows an exemplary Context Aware Content Presentation (CACP) system 10 that renders video content delivered to a display device 12 in accordance with the context, that is to say, the relationship, of a viewer 14 to the display device. A viewer context feedback determination mechanism 16 determines the context of the viewer 14 relative to the display device 12. To that end, the viewer context feedback determination mechanism 16 can include an infrared camera (not shown) mounted on the display device 12 for detecting signals transmitted from an infrared transmitter (not shown) worn by the viewer 14. A processor (not shown) comprising part of the viewer context feedback mechanism 16 processes the output signal of the camera using well known techniques to yield information as to the distance of the viewer from the camera on the display device 12. The viewer context feedback determination mechanism 16 can also provide other viewer context information, including but not limited to, viewer look-at position, the nature of viewer movement, viewing angle, and viewer identification.

A rendering module 18 receives the viewer context information from the viewer context feedback determination mechanism 16 and renders content already delivered to the display device 12 in accordance with such information. In other words, the rendering module dynamically 18 adapts the content displayed by the display device 12 to changes in viewer context. While the rendering module 18 appears in FIG. 1 as a separate, stand-alone unit, typically in the form of a personal computer or set-top box for example, the rendering module could comprise part of the display device 12.

The Context-Aware Content-Presentation (CACP) system 10 of FIG. operates on previously delivered content. Thus, the viewer's context does not the manner in which content undergoes delivery to the display device 12.

FIG. 2 depicts a CACP system 100 in accordance with a preferred embodiment of the present principles which can control the quality of video content streamed to a display device 12 according to the context of a viewer 14. The CACP system 100 can adjust various video content parameters (resolution, bit rate, etc.) based on different types of viewer context information (viewer distance, viewer look-at position, nature of movement, viewing angle and viewer identification, etc.), as determined by a viewer context feedback determination mechanism 16 configured similarly to the viewer context feedback determination mechanism 16 of FIG. 1.

The viewer context feedback determination mechanism 16 of FIG. 2 provides viewer context information (viewer distance, viewer look-at position, nature of movement, viewing angle, viewer identification, etc.) to a content receiving device 18′, for example a set-top box or the like which controls the quality of video content streamed from a server 20 to the display device 12. Control of the video content quality in accordance with viewer context can occur in several different ways as discussed hereinafter.

### 1. Controlling Video Quality Based on Viewer Distance

The visual quality of video content depends on the resolution and bit rate chosen for encoding the content. The higher the resolution and bit rate are, the higher the quality in general, all other factors remaining constant. In the case of streaming applications, higher quality video requires higher bandwidth. The closer the viewer to the screen, the higher quality video needed to ensure a good viewing experience since details and artifacts become much more apparent at close distances. A viewer farther away from the screen will likely not see details and artifacts as clearly, allowing a decrease in the video quality, which would result in a bandwidth savings without sacrificing viewing experience. The same decrease could occur as the viewing angle increases. Conversely, a decrease in viewing angle, as measured normal to the screen, would require greater resolution and increased bandwidth. In this example, a reduction in bandwidth usage can occur by streaming higher quality video only when necessary to do so, based on the viewer distance from the display device 12 or the increase in viewing angle.

Referring to FIG. 2, the CACP system 100 monitors the viewer distance from the display device via the viewer content feedback mechanism 16 and provides the viewer distance information to the content receiving device 18′. During intervals while the viewer remains close to the screen, the content receiving device 18′ provides the streaming server 20 with a request for streaming at a high-resolution and a high bit rate. In response, the streaming server 20 will stream the video content to the display device 12 at the requested high resolution and bit rate, thereby assuring a high quality viewing experience. As the viewer distance from the display device 12 increases, the viewer context feedback mechanism 16 provide such information reflecting the change in viewer context to the content receiving device 18′. In turn, the content receiving device 18′ requests that the streaming server 20 progressively decrease the resolution and bit rate of the streamed video to a point.

Various mechanisms exist to convey to the streaming server 20 the request to change the quality of the video stream. For example, a local server in a home network (not shown) could receive the request, or a remote streaming server could receive the request over an appropriate communication channel (e.g. IP). The streaming server 20, in turn, dynamically adapts the streamed content, by controlling at least one of the bit rate or resolution or both. Subjective viewing tests can determine the relation between viewer distance and the video content parameters.

In one embodiment, scalable video coding (SVC) can serve to dynamically vary the quality of the video content. While the viewer remains far away from the screen, only the base layer of the video content would undergo transmission. As the distance between the viewer and the display device 12 of FIG. 2 decreases, thus requiring higher quality video, enhancement layers would get streamed as well to realize a better quality video. Spatial scalability can serve to vary the resolution and bit rate scalability to vary the bit rate.

### 2. Adapting Video Quality Based on Viewer Look-at Location

When watching video, viewers typically do not pay attention to all portions of the picture but tend to focus on certain regions of interest. Knowledge of these regions of interest would enable streaming or rendering of such regions with higher quality than other regions. Selectively streaming or rendering such regions of interest will make better use of available bandwidth and processing power.

The CACP system 100 of FIG. 2 can advantageously track viewer's gaze to determine the regions of attention and stream or render these regions with higher quality. Slice partitioning can serve to encode the regions of attention as separate slices with a higher quality. Alternatively, SVC can serve to stream enhancement layers to improve the quality of these regions.

A calibration process can serve to determine the viewer's look-at point by determining the correspondence between the viewer's head position and the look-at point. For example, the viewer context feedback mechanism 16 of FIG. 2 can record the viewer's head positions when the viewer looks at the top-left and bottom-right corners of the screen of the display device 12. Based on these correspondences, the viewer context feedback mechanism 16 can map the viewer's intermediate head positions to specific look-at points on the screen of the display device 12. For example, the viewer context feedback mechanism 16 of the CACP system 100 of FIG. 2 can make use of IR emitters (not shown) on a pair of glasses worn by the viewer and an IR detector (e.g. an IR camera with a processing unit) (not shown) that detects the head position based on the emitted signals.

### 3. Application to Real-Time Video Rendering

The concept of video quality adaptation can extend beyond the streaming application depicted in FIG. 2. Applications such as gaming require real-time video rendering. Rendering in high resolution takes time and can cause lags, affecting the user viewing experience. The techniques described earlier could serve to adapt the rendering resolution based on viewer distance and look-at location. In the former case, rendering resolution decreases with increases in the viewer distance from the display device 12. In the latter case, regions of interest get rendered in higher resolution than others. Therefore, by using viewer context feedback, better utilization of processing resources can occur, as well as reductions in lags during rendering.

The CACP system 100 of FIG. 2 can make use of other environmental contexts besides viewer distance and viewer look-at location. For example, the CACP system 100 of FIG. 2 could take account of ambient viewing conditions, such as ambient lighting for example.

1. A method for varying video quality in accordance with viewer context relative to a display device, comprising the steps of:
establishing the viewer's context relative to the display device; and
controlling at least one parameter of video content provided to the display device in accordance with the established viewer context to vary the video quality.

2. The method according to claim 1 wherein the at least one parameter includes video content bit rate.

3. The method according to claim 1 wherein the at least one parameter includes video content bit resolution.

4. The method according to claim 2 wherein both bit rate and resolution of the video content are controlled in accordance with the established viewer context.

5. The method according to claim 1 wherein the viewer context includes at least one of: viewer distance, viewer look-at position, nature of viewer movement, viewing angle, and viewer identification.

6. The method according to claim 1 wherein the viewer context includes the viewer distance from the display device and wherein bit rate and resolution of the video contend are reduced upon an increase in viewer distance from the display.

7. The method according to claim 1 wherein the viewer context includes the viewer distance from the display device and wherein bit rate and resolution of the video contend are increased upon a reduction in viewer distance from the display.

9. A method for varying video quality in accordance with viewer look-at position, comprising the step of selectively performing at least one of rendering or streaming regions within the video content corresponding to the viewer look-at position with higher quality compared to regions which do not correspond to the viewer look-at position.

10. The method according to claim 1 wherein the viewer context includes viewer viewing angle relative to the display device and wherein bit rate and resolution of the video contend are reduced upon an increase in viewing angle.

11. The method according to claim 1 wherein the viewer context includes viewer viewing angle relative to the display device and wherein bit rate and resolution of the video contend are increased reduced upon an decrease in viewing angle

12. An apparatus for varying video quality in accordance with viewer context relative to a display device, comprising the steps of:
means for establishing the viewer's context relative to the display device; and
means for controlling at least one parameter of video content provided to the display device in accordance with the established viewer context to vary the video quality.

13. The apparatus according to claim 12 wherein the means for controlling at least one parameter of the video quality comprises a set-top box.

14. The apparatus according to claim 12 wherein the viewer context includes at least one of: viewer distance, viewer look-at position, nature of viewer movement, viewing angle, and viewer identification.

15. The apparatus according to claim 12 wherein the viewer context includes the viewer distance from the display device and the means for controlling the at least one parameter reduces bit rate and resolution of the video contend upon an increase in viewer distance from the display.

16. The apparatus according to claim 12 wherein the viewer context includes the viewer distance from the display device and the means for controlling the at least one parameter increases bit rate and resolution of the video contend upon a decrease in viewer distance from the display.

17. Apparatus for varying video quality, comprising:
means for establishing a region of interest looked at by a viewer on a display device; and
means for selectively performing at least one of rendering or streaming the region of interest within the video content corresponding looked at by the viewer with higher quality compared to regions not looked at by the viewer.
